(19) United States
(12) Patent Application Publication
(10) Pub. No.: US 2015/0298988 A1
(43) Pub. Date: Oct. 22, 2015

(54) IONIC NANOCRYSTALLINE MATERIALS WITH HIGH SURFACE CHARGE DENSITY AND COMPOSITES OF THE SAME

(71) Applicants: Brett A. Helms, San Francisco, CA (US); Sean E. Doris, San Francisco, CA (US); Changyl Li, Berkeley, CA (US)

(72) Inventors: Brett A. Helms, San Francisco, CA (US); Sean E. Doris, San Francisco, CA (US); Changyl Li, Berkeley, CA (US)

(21) Appl. No.: 14/691,525

(22) Filed: Apr. 20, 2015

Related U.S. Application Data
(60) Provisional application No. 61/981,668, filed on Apr. 18, 2014.
(60) Provisional application No. 62/062,000, filed on Oct. 9, 2014.

(51) Int. Cl. C01G 23/047; C01G 45/02; C22B 3/00; C07F 11/00; B29C 39/00; C22C 19/03; C01B 19/00; C01G 9/02

(52) U.S. Cl. CPC C01G 23/047; C01B 19/007; C01G 45/02; C01G 9/02; C07F 11/00; B29C 39/003; C22C 19/03; C22B 23/0415; C22B 23/0423

(57) ABSTRACT

Materials, methods to prepare, and methods of use for ionic nanocrystalline inorganic materials and hybrid composites thereof are described herein. A preferred embodiment comprises native ligand stripping under equilibrium control, where reversible Lewis acid-base chemistry is used to generate adduct-stabilized surfaces during ligand stripping. Through a preferred embodiment, the generation of physisorbed anionic species that stabilize the nanocrystal surface until coordinating solvent is able to repassivate the surface.

### RELATED APPLICATIONS

This Non-Provisional patent application is related and claims priority to U.S. Provisional Patent Application No. 61/981,668 filed Apr. 18, 2014 and U.S. Provisional Patent Application No. 62/062,000 filed Oct. 9, 2014, both of which are incorporated herein by reference in their entirety.

### STATEMENT OF GOVERNMENT SUPPORT

The United States Government has rights in this invention pursuant to DOE Contract No. DE-AC02-05CH11231 between the U.S. Department of Energy and the University of California, as operator of Lawrence Berkeley National Laboratory.

### FIELD OF THE INVENTION

One or more embodiments consistent with the present disclosure relate to ionic nanocrystalline inorganic materials, methods of their preparation, and methods for using the compounds described in various applications.

### BACKGROUND

Mesoscale chemistry increasingly relies on assembly of pre-formed nanoscale building units into ordered hybrid architectures. The surface chemistry of the building units strongly influences their assembly trajectory from spatially random to periodically ordered mesostructures, which in turn allows one to engineer new properties from the coupled interactions amongst components in the material. Colloidal nanocrystals are versatile building units in this regard. As synthesized, they typically feature a dense packing of hydrophobic organic ligands, chemisorbed to the nanocrystal's inorganic surface. Others and we have shown previously that in order to assemble nanocrystals into ordered mesostructured materials, particularly at high volume fractions, their surfaces must first be transformed chemically to enable favorable interactions with block copolymer (BCP) architecture-directing agents. Understanding the mechanistic origins and outcomes that allow nanocrystal surfaces to be primed for BCP-directed assembly is therefore critical to advancing the emerging field of mesoscale science.

Despite the growing number of useful ligand exchange and ligand stripping chemistries now available, we are only beginning to understand the mechanistic underpinnings of those transformations. It is still difficult to explain and predict trends in reactivity for different nanocrystal compositions for a given transformation. For example, some nanocrystal compositions have not been amenable to native ligand removal while also maintaining colloidal dispersability—e.g., the lead chalcogenides. Disparities in surface reactivity and stability are related to structure and bonding available to the material, and demand that we develop an arsenal of reagents that can be tailored as needed for the desired transformation of a nanocrystal of interest.

In the past, we and others have used irreversible chemical reactions, including alkylation with Meerwein's salt or oxidation by the nitrosyl cation, to drive the removal of ligands from nanocrystal surfaces. These reactions yield charge-stabilized colloids in polar dispersants due to open metal coordination sites left at the nanocrystal surface following ligand stripping (Scheme 1a). Chemical approaches based on such irreversible reactions leave behind a transiently unstable surface (i.e., absent any stabilizing adsorbates), which can lead to desorption of excess metal cations from the surface and loss of dispersability (due to loss of surface charge) on a timescale similar to re-passivation with coordinating solvent.

### SUMMARY

A class of ionic nanocrystalline inorganic materials and hybrid composites thereof is described herein. These materials and hybrid composites may be fabricated using a chemical process in which colloidal nanocrystals coated with organic surfactants generate dispersible ionic nano-inks with high surface charge density when treated with Lewis acid-base adducts in the presence of a coordinating solvent. These materials may constitute building blocks for nano-ionic materials, such as ionic nanocomposites when combined with polymers or mesostructured ionic nanocomposites when combined with block copolymers, for example.

One or more of the embodiments described herein can be used to form highly ionic nanocrystalline materials for broad classes of material compositions, including metallic, semiconducting, and insulating compositions, some of which were previously unobtainable by other methods (e.g., lead chalcogenides). For many nanocrystal compositions, the surface charge density is exceptionally high and notably so compared to any previously reported. This unique property may make the use of these nanocrystal compositions as components in nanoionic materials highly desirable. These properties may impart unique behaviors in composite materials, including enhanced ion transport relevant to energy storage, for example.

One challenge in the fabrication of the nanocrystals described herein was to control and mitigate the desorption of metal ions from nanocrystal surfaces during the preparation of the nano-ionic materials. In some embodiments, this was accomplished by employing reversible Lewis acid-base chemical reactions to gently remove surfactants from the nanomaterial surface while maintaining electrostatic stabilization of the surface.

Advances in ligand-stripped colloidal nanocrystal building blocks have previously been reported by Murray et al. (J. Am. Chem. Soc., 2011, 133, pp 998-1006) and Rosen et al. (Angew. Chem. Int. Ed. 2012, 51, pp 684-689); both of these papers are herein incorporated in their entirety by reference. Further advances made beyond what was previously achievable include the enhanced surface charge density that is achievable using the methods described herein and the greater versatility in choice of nanocrystal compositions from which these ionic nanocrystalline materials, and the expanded types of hybrid composites thereof, can be produced.

Also incorporated by reference in their entirety is a journal article entitled “Mechanistic Insight into the Formation of Cationic Naked Nanocrystals Generated under Equilibrium Control” and a document entitled “Supporting information for Mechanistic Insight into the Formation of Cationic Naked Nanocrystals Generated under Equilibrium Control”.

### BRIEF DESCRIPTION OF THE DRAWINGS

These and other features, aspects, and advantages of the multiple embodiments of the present invention will become better understood with reference to the following description, appended claims, and accompanied drawings where:

Scheme 1: Mechanistic grounds distinguishing various native ligand stripping chemistries that yield cationic naked nanocrystals. X⁻=anionic ligand, E=electrophile, Y⁻=non-coordinating anion, M^{m+}=metal ion, LA:LB=Lewis acid-base adduct, L=charge-neutral coordinating solvent (e.g., DMF). a) Irreversible ligand stripping by strong electrophiles yields a cationic nanocrystal surface with no electrostatic stabilization. For sensitive nanocrystal compositions, loss of M^{m+} from the surface leads to colloidal instability, particularly when re-passivation of surface M^{m+} by L is not competitive with M^{m+} desorption. b) Ligand stripping under equilibrium control stabilizes the cationic nanocrystal surface through dynamic interactions with an anionic physisorbed species [LA:X]⁻ until it can be re-passivated with L. The dynamic exchange of [LA:X]⁻ on and off the nanocrystal differentiates stripping under equilibrium control from earlier approaches. In the approach described herein, Y⁻ is generated through disproportionation of [LA:X]⁻ as described in the main text.

FIG. 1: Titration of PbSe-OA in tolune-d₈ with BF₃:Et₂O. a) ¹H spectra of the alkene resonance of oleate after addition of 0, 0.5, 1.2, and 1.6 equivalents (with respect to oleate) BF₃:Et₂O. b) Measured diffusion coefficient for the broad (OA⁻) and sharp ([OA:BF₃]⁻) resonances as a function of added BF₃:Et₂O. c) Representative DOSY plot of PbSe-OA+0.5 equivalents BF₃:Et₂O. For clarity, integration regions for the DOSY spectrum were manually defined to avoid regions where overlapping peaks led to artifacts in the DOSY spectrum. Dashed lines corresponding to the diffusion coefficients of PbSe-OA and free oleic acid, measured separately, are included for comparison. * indicates solvent and † indicates Et₂O.

FIG. 2: ¹⁹F NMR evidence for BF₄⁻ as a non-coordinating counter-ion in naked PbSe NC dispersions. a) and b) depict ¹⁹F NMR of NaBF₄ and naked PbSe nanocrystal in DMF, respectively. Identification of the species as BF₄⁻ was made on the basis of similar chemical shifts. The slight difference in chemical shifts can be attributed to concentration and dielectric effects. c) and d) depict ¹⁹F-DOSY spectra for NaBF₄ and naked PbSe nanocrystal in DMF, respectively. On the basis of this data, it is clear that BF₄⁻ is only weakly, if at all, associating with the nanocrystal surface in this high dielectric constant dispersant.

Scheme 2: Disproportionation of DMF:BF₃. DMF:BF₃ initially forms via an exchange of BF₃ from the weaker Lewis base diethyl ether to the more basic DMF (not shown). The DMF:BF₃ adduct is resonance stabilized. This adduct can react with a second equivalent of BF₃:DMF in a fluoride transfer reaction to yield BF₄⁻ and [BF₂DMF]⁺. Finally, the open coordination site on boron is filled by DMF to yield [BF₂(DMF)₂]⁺.

Scheme 3: Reaction pathways available to OA⁻ in the presence of BF₃:Et₂O to yield BF₄⁻. OA⁻ forms adducts with either one or two equivalents of BF₃ to give intermediates 2 and 3, respectively. Compound 2 undergoes disproportionation, yielding [B(OA)₂F₂]⁻ and BF₄⁻. Alternatively, 2 can transfer a fluoride to BF₃:Et₂O to give a charge-neutral species 5 and BF₄⁻. Species 5 dimerizes readily, and is observable as compound 6 in the presence of adventitious H₂O during the ESI-MS measurement. BF₃-mediated disproportionation of 3 is also observable along the reaction pathway proposed. Chemical structures for 1, 2, 3, 4, 6, and 7 (gray) were verified by ESI-MS.

FIG. 3: a) High resolution negative-ion mode ESI-MS of Pb(OA)₂+BF₃:Et₂O. Six of the species proposed in Scheme 3 were identified in the mass spectrum and are boxed for clarity. Isotope distribution patterns for b) OA⁻, c) [OA:BF₃]⁻, d) [OA(BF₂)(BF₂O)]⁻, e) [OA(BF₃)₂]⁻, f) [B(OA)₂F₂]⁻, and g) [(OA)₂(BF₂)(BFO)]⁻ are shown (bottom trace) along with predicted patterns (top trace).

FIG. 4: a) Comparison of different ligand stripping reagents for PbSe-OA:NOBF₄ rapidly oxidizes PbSe yielding the red allotrope of Se⁰ (left); application of Meerwein's salt yields stoichiometric PbSe with poor dispersability (middle); ligand stripping with Lewis base adducts of BF₃ (right) yields stable dispersions of cationic naked PbSe nanocrystal. b) PbSe-OA form hcp superlattices when deposited from stable dispersions in aliphatic hydrocarbons. c) In-film removal of oleates in hcp-ordered PbSe-OA films by Lewis-base adducts of BF₃ destroys ordering and can introduce cracking d) Film deposition from cationic naked PbSe nanocrystal inks yields large-area, ordered films with improved film quality. All scale bars are 100 nm.

FIG. 5: PbSe polymer composites deposited directly from solution. a) and b) display top-down SEM of a composite at increasing magnification, with scale bars of 500 and 200 nm, respectively. c) shows a GISAXS pattern taken at an incident angle of 0.16° and sample-detector distance of 3.9 m and d) shows a line scan along the q_{y} axis of the GISAXS pattern.

FIG. 6: Top panel shows reaction proceeding without stabilization of surface ligands leading to colloidal instability. Bottom panel shows reaction proceeding with stabilization of surface ligands with Lewis acid-base adducts leading to a retention of colloidal stability.

FIG. 7: Energy dispersive X-ray (EDX) spectra of a) PbSe, b) Cu_{1.7}Se, c) Ni, d) ZnO, e) Mn₃O₄ and f) TiO₂ nanocrystals on Si before (dashed) and after (solid) ligand stripping. All spectra are scaled to aid in comparison. In all cases, a dramatic decrease in carbon content indicates ligand removal. Additionally, a new peak for fluorine is commonly observed, which agrees with FT-IR and NMR evidence for BF₄⁻ counter-ions. Changes in the Si peak are indicative of different film thicknesses and are not related to the stripping process. All measurements were performed with an electron beam energy of 5 keV except for TiO₂, which was performed at a beam energy of 10 keV.

FIG. 8: TEM of ligand-coated and ligand-stripped nanocrystal. For each composition, ligand coated nanocrystal are on the left and ligand-stripped on the right. Removal of native ligands from the nanocrystal surface results in decreased inter-particle spacing, but does not result in significant etching or damage to the inorganic nanocrystal core. All scale bars are 5 nm.

FIG. 9: SEM of ligand-stripped PbSe thin-film deposited from solution: an enlarged field of view of the data presented in FIG. 4d. Scale bar is 100 nm.

FIG. 10: SEM of a ligand-stripped PbSe-block copolymer mesostructured composite: an enlarged field of view of the data presented in FIG. 5b. Scale bar is 200 nm.

### DETAILED DESCRIPTION

The following description is provided to enable any person skilled in the art to use the invention and sets forth the best mode contemplated by the inventor for carrying out the invention. Various modifications, however, will remain readily apparent to those skilled in the art, since the principles of the present invention are defined herein specifically to provide description of ionic nanocrystalline inorganic materials, methods of their preparation, and methods for using such materials.

We hypothesized that this undesirable outcome could be avoided if it were possible to stabilize the nanocrystal surface through the entire ligand-stripping pathway. Here, we introduce the concept of native ligand stripping under equilibrium control, where reversible Lewis acid-base chemistry is used to generate adduct-stabilized surfaces during ligand stripping. The dynamic exchange of these adducts on and off the nanocrystal surface allows for ligand displacement while imparting surface stabilization, in contrast to previous approaches that leave the surface without stabilization. Our concept of equilibrium control over ligand stripping is demonstrated using Lewis base adducts of BF₃, which yield for the first time naked nanocrystal inks of PbSe, along with a wide range of other semiconductor and metallic nanocrystals. Our analysis of excess surface Pb(II) before and after stripping under equilibrium control indicated near complete retention of excess Pb(II), in contrast with irreversible ligand stripping approaches. To rationalize differences in ligand-stripping outcomes with different reagents, we investigated in detail the mechanism of oleate ligand removal from PbSe nanocrystals using complementary in situ techniques, including both 1D and 2D nuclear magnetic resonance (NMR) spectroscopy for both ¹H- and ¹⁹F-containing reaction intermediates, as well as electrospray ionization mass spectrometry (ESI-MS) in order to validate our structure assignments.

Unique to the chemistry disclosed herein, we show that BF₃ reacts with the carboxylate terminus of PbSe-bound oleate ligands (OA⁻) to form a physisorbed [OA:BF₃]⁻ adduct that is in dynamic exchange (equilibrium) on-and-off the nanocrystal surface throughout the stripping reaction. We reason that this dynamic layer of [OA:BF₃]⁻ at PbSe is responsible for the observed surface stabilization, and refer to this effect as equilibrium control over surface stabilization. We further show that anionic [OA:BF₃]⁻ undergoes disproportionation reactions in the presence of excess BF₃, ultimately leading to the loss of oleate as neutral OAₓ(B_{y}F_{z}) species and the formation of BF₄⁻ as the sole charge-compensating species at the cationic nanocrystal surface in the final naked nanocrystal dispersion. The quality of these nano-inks allows PbSe nanocrystal to be assembled into either single-component ordered nanocrystal films or periodic mesostructured composites using block copolymer-directed assembly, highlighting the versatility of these functional nanoscale building units in mesoscale chemistry.

As a test case to highlight the versatility of native ligand stripping under equilibrium control over previously reported procedures, we investigated in detail the removal of oleate ligands from the surface of PbSe nanocrystal (PbSe-OA) using Lewis base adducts of BF₃. As Se²⁻ in the nanocrystal lattice is easily oxidized, PbSe nanocrystals require mild chemical reagents to strip them of their native ligands. While reagents such as trialkyloxonium salts (e.g., Meerwein's salt) and 1-alkoxy-N,N-dimethylmethaminium salts have so far proven capable of stripping ligands from the nanocrystal surface, by either method, the resulting naked PbSe nanocrystals are not dispersable in organic solvents. Both alkylating agents are high-energy reactants and their use is commensurate with rapid and irreversible removal of chemisorbed organic ligands from nanocrystal surfaces. For nanocrystals such as PbSe, loss of native ligands from the coordination sphere of surface Pb(II) can lead to desorption of Pb(II) from the nanocrystal surface. Here, we show that by changing the ligand-stripping chemistry to one that allows for equilibrium control over surface stabilization, we are able to completely avoid loss of surface Pb(II) and thereby preserve colloidal stability in the cationic naked PbSe nanocrystal inks.

Stable dispersions of cationic naked PbSe nanocrystal with BF₄ counter-ions were obtained by direct transfer of PbSe-OA into N,N-dimethylformamide (DMF) containing BF₃:Et₂O. The resulting PbSe dispersions—purified first by hexanes washes and then precipitation from DMF with toluene—were stable to centrifugation and filtration for days. The efficient removal of ligands by Lewis base adducts of BF₃ (BF₃:LB) was confirmed by FT-IR and EDX, which show a dramatic decrease in intensity of the C—H vibrational stretching frequencies and carbon content, respectively (FIG. S2). Ligand removal was further verified by carrying out the stripping procedure in DMF-d₇ and acquiring the ¹H NMR spectrum, which showed no residual oleate. In order to establish the compositional diversity afforded by ligand stripping under equilibrium control, we showed that charge-stabilized dispersions of naked ZnO, Mn₃O₄, TiO₂, and Ni can be prepared in a similar manner to that described for PbSe. Despite the dramatic change in nanocrystal surface chemistry, we did not observe dramatic changes in size or crystal structure, as evidenced by TEM and XRD. Thus, this approach efficiently removes organic ligands from nanocrystal surfaces while preserving the integrity of the inorganic nanocrystal core.

In order to understand the microscopic chemical processes leading to stable dispersions of naked PbSe nanocrystals, we followed the ligand stripping chemistry of PbSe-OA in situ in toluene-d₈ using diffusion-ordered spectroscopy (DOSY). DOSY is a 2D NMR technique that provides information about the chemical shifts and diffusion coefficients of NMR active species, and has been used to identify and track the dynamics of ligand exchange (but not stripping) on a variety of nanocrystal surfaces. The ¹H DOSY spectrum of 6.8±0.5 nm PbSe-OA nanocrystals showed broad peaks with chemical shifts characteristic of bound oleate and a diffusion coefficient of (0.75±0.01)×10⁻¹⁰ m² s⁻¹. This contrasts significantly with the diffusion coefficient of free oleic acid of (7.75±0.05)×10⁻¹⁰ m² s⁻¹. The measured diffusion coefficient for PbSe-OA corresponds to a hydrodynamic diameter of 10.0±0.5 nm, which agrees well with a 6.8 nm PbSe core and a tightly bound ˜1.6 nm ligand shell on each side.

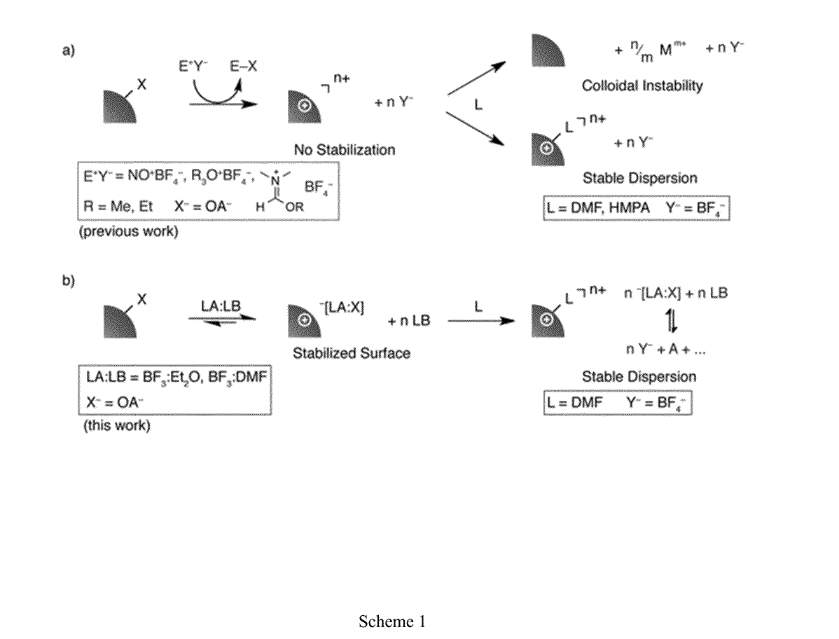

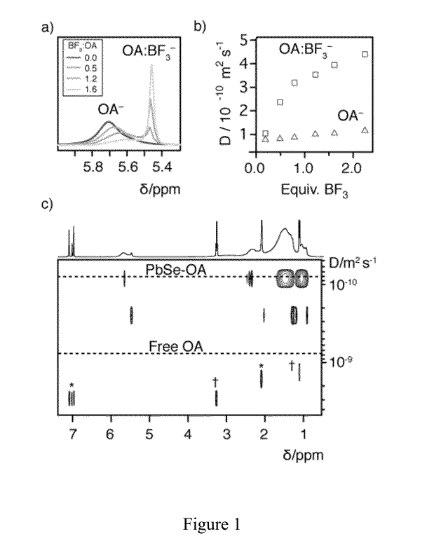

The broad alkene resonance at 6=5.7 ppm is well separated from other resonances in the ¹H NMR spectrum and provides an ideal handle for tracking the fate of oleate as ligand stripping progresses. As BF₃:Et₂O was added to the nanocrystal dispersion, the broad oleate alkene resonance shifted upfield and decreased in intensity while a sharp resonance at δ=5.4-5.5 ppm, which we assign to [OA:BF₃]⁻, appeared and grew in intensity (FIG. 1a). The measured diffusion coefficient of the broad resonance increased only slightly throughout the experiment (from (0.75±0.01) to (1.20±0.02)×10⁻¹⁰ m² s⁻¹), but the measured diffusion coefficient of the sharp resonance increased from (1.02±0.03)×10⁻¹⁰ m² s⁻¹ at 0.2 equivalents BF₃ to (4.43±0.02)×10⁻¹⁰ m² s⁻¹ at 2.3 equivalents BF₃ (FIG. 1b). This can be explained by oleate reacting with BF₃:Et₂O to form [OA:BF₃]⁻ and Et₂O. As the negative charge of [OA:BF₃]⁻ is more diffuse than OA⁻, [OA:BF₃]⁻ is expected to bind much less strongly to the nanocrystal surface. As a result, [OA:BF₃]⁻ rapidly exchanges on and off the nanocrystal, and the observed diffusion coefficient is a weighted average between the bound and unbound states.

As the titration proceeded, [OA:BF₃]⁻ became increasingly liberated from the surface. On the other hand, unreacted oleate remained tightly bound to the nanocrystal. As more of the ligand shell was removed, the remaining oleate ligands experienced more configurational entropy (or conformational degrees of freedom), allowing them to reconfigure at the ligand-nanocrystal interface. As a result, the hydrodynamic diameter of the nanocrystal, as measured by DOSY of the broad resonance at δ=5.7 ppm, decreased from 10.0±0.5 nm (inorganic core+ligand shell) to 6.3±0.3 nm (inorganic core alone) over the course of the titration. Changes in the chemical shift for tightly bound oleate can be explained by changes in the local dielectric environment as neighboring oleate ligands are removed. These results provide strong support that [OA:BF₃]⁻ adducts are exchanging on-and-off the surface of PbSe nanocrystals during the stripping process, thus stabilizing the surface against surface metal cation desorption. Alternate explanations for the sharp peak at 6=5.5 ppm were considered, but found to be inconsistent with our observations. For example, we considered that the sharp resonance at 6=5.5 ppm could be due to the exchange of charge-neutral Pb(OA)₂, which Hens and co-workers observed in the case of PbSe-OA oxidation. However, we found that Pb(OA)₂ is unstable in the presence of BF₃, making this hypothesis unlikely. Furthermore, all experiments were carried out in tightly sealed screw-top NMR tubes, which were immediately transferred from a glovebox into the NMR spectrometer in order to avoid oxygen exposure. We also ruled out the possibility that [OA:BF₃]⁻ was merely becoming entangled in the ligand shell rather than exchanging on and off the nanocrystal surface by considering that the diffusion coefficient measured at 2.3 equivalents of added BF₃:Et₂O indicated that the species was still spending some time diffusing with the nanocrystal, despite the almost complete loss of the ligand shell at this point in the titration.

Support that BF₃:Et₂O-mediated equilibrium-controlled ligand stripping avoids loss of surface excess Pb(II) was provided by measurement of the PbSe nanocrystals' surface excess Pb(II) before and after stripping using inductively coupled plasma atomic emission spectroscopy (ICP-AES). As-synthesized 5.8±0.5 nm diameter PbSe-OA nanocrystals gave a Pb:Se ratio of 1.24±0.03, while naked PbSe returned with a 1.23±0.02 ratio of Pb:Se. This retention of surface excess Pb(II) during ligand stripping is unique among agents that generate naked PbSe nanocrystals: a ˜1:1 ratio is typically observed when using Meerwein's salt directly, while a 1.15:1 ratio is observed when using 1-ethoxy-N,N-dimethylmethaminium tetrafluoroborate. Moreover, our new BF₃:LB approach is the only procedure that yields dispersible naked PbSe, most likely due to the enhanced electrostatic stabilization that follows retention of excess surface Pb(II). Based on these data, it is then appropriate to describe the composition of naked PbSe nanocrystals as (Pb²⁺)_{0.23n}(Y⁻)_{0.46n}(PbSe)ₙ where n is ˜1600 and Y⁻ is the counter-ion generated during ligand stripping.

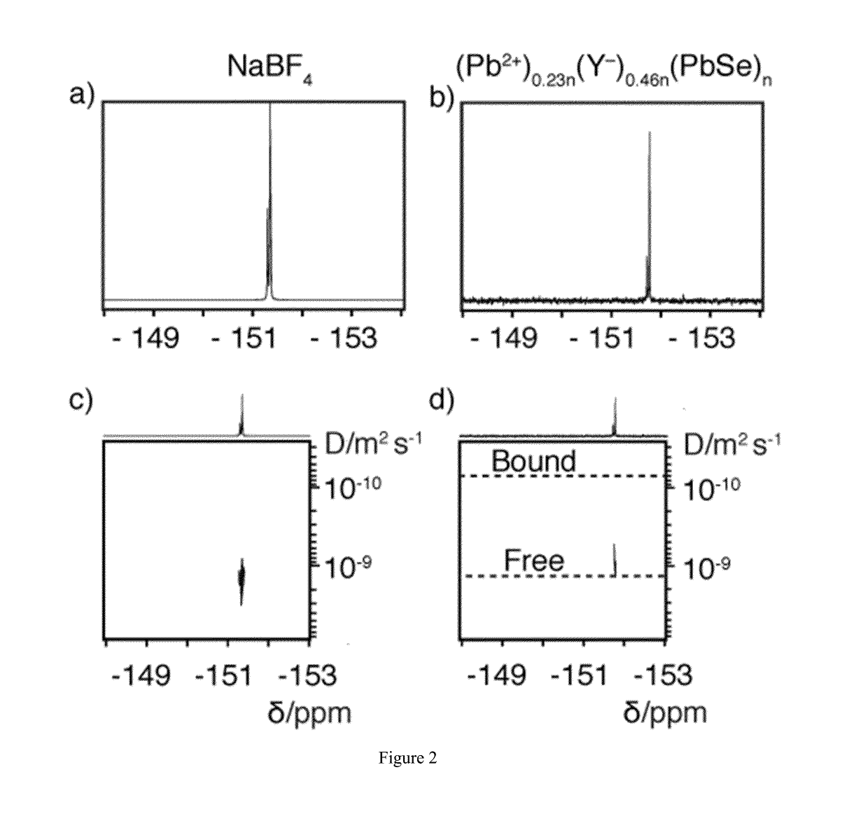

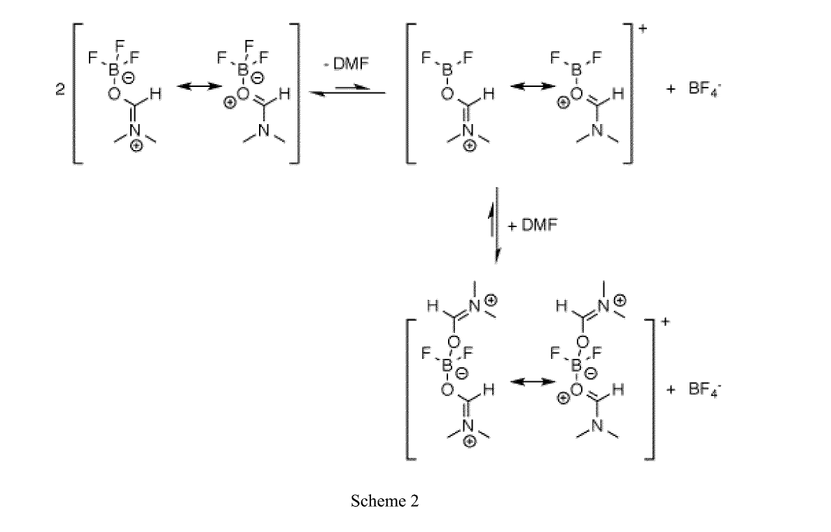

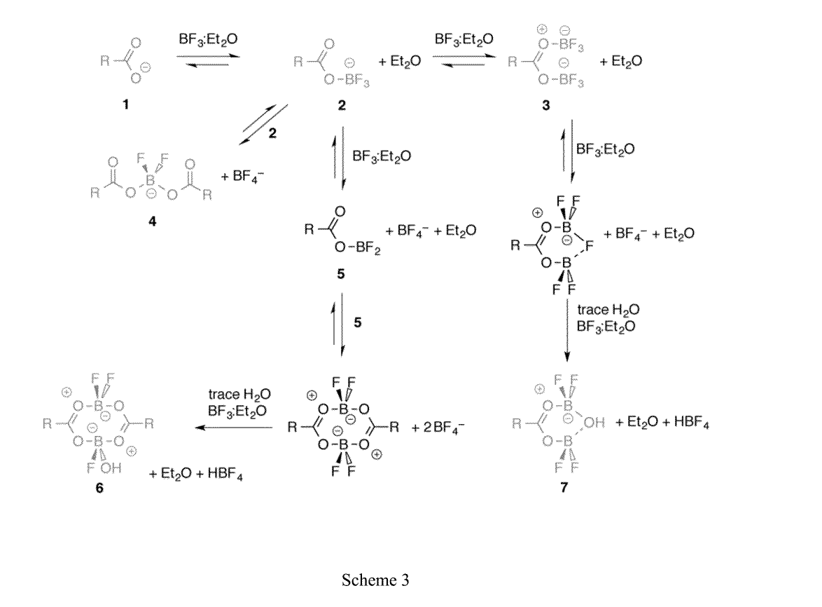

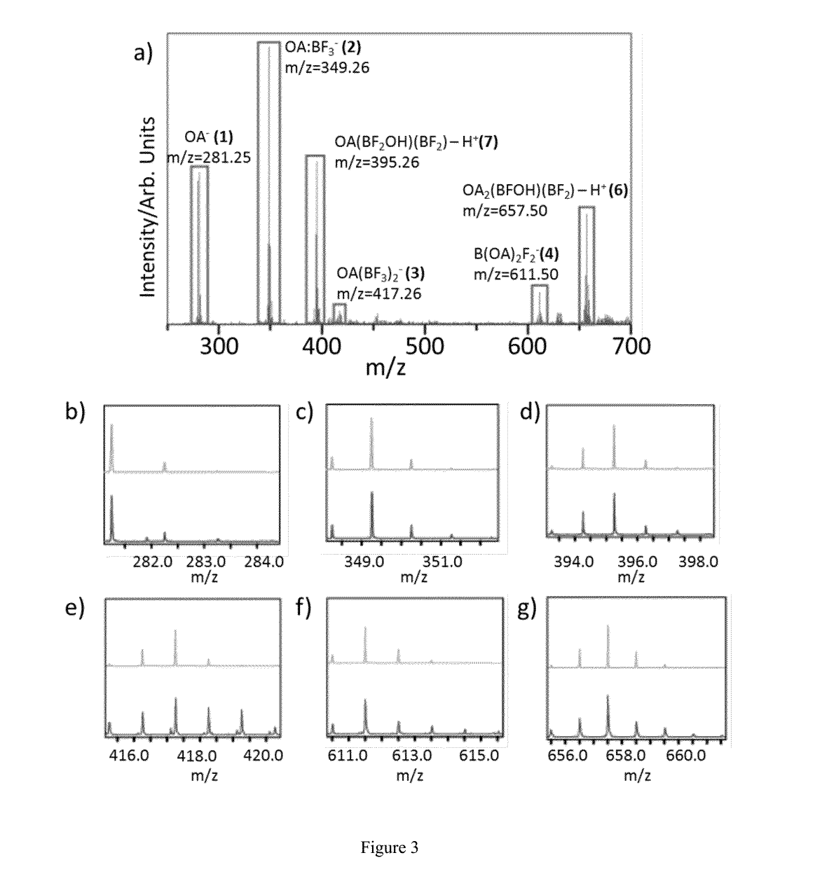

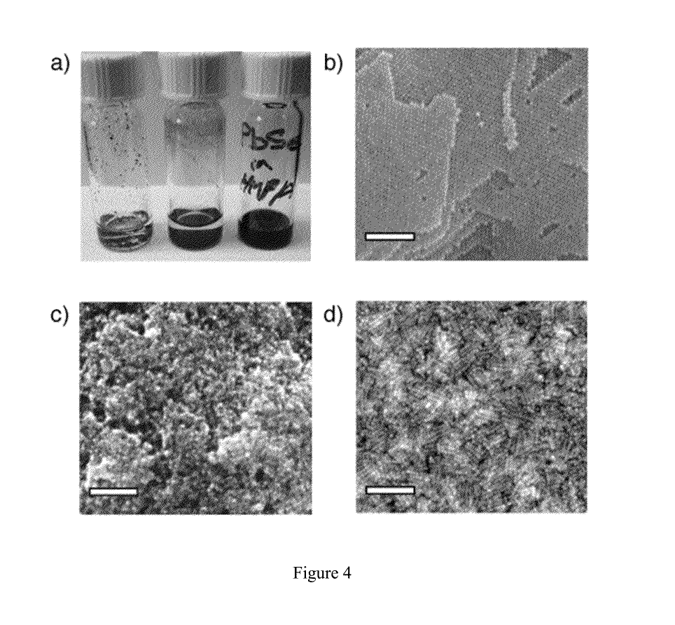

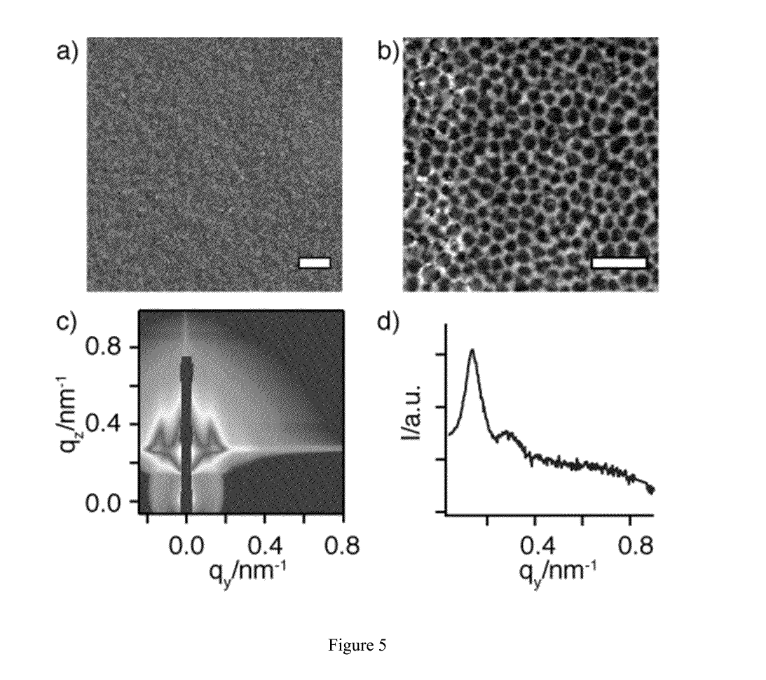

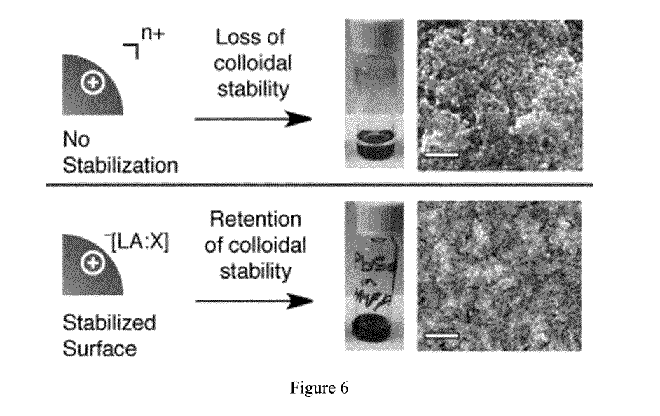

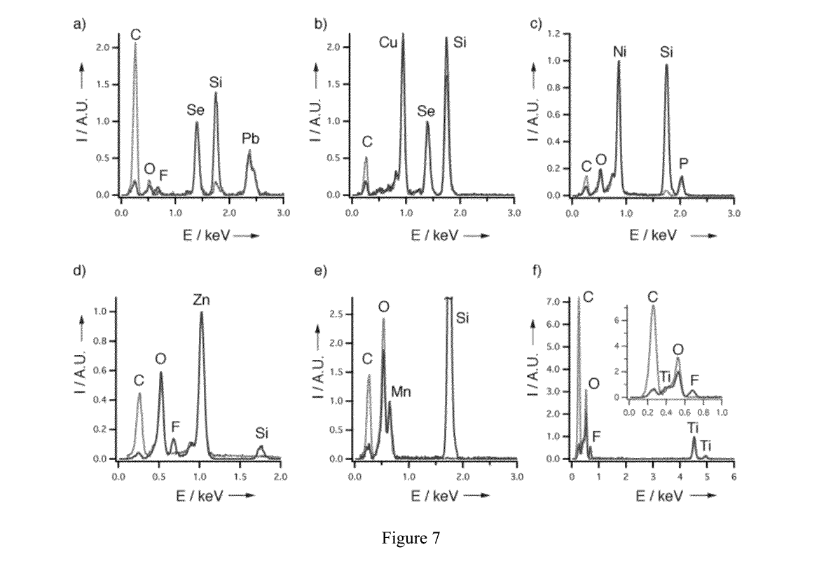

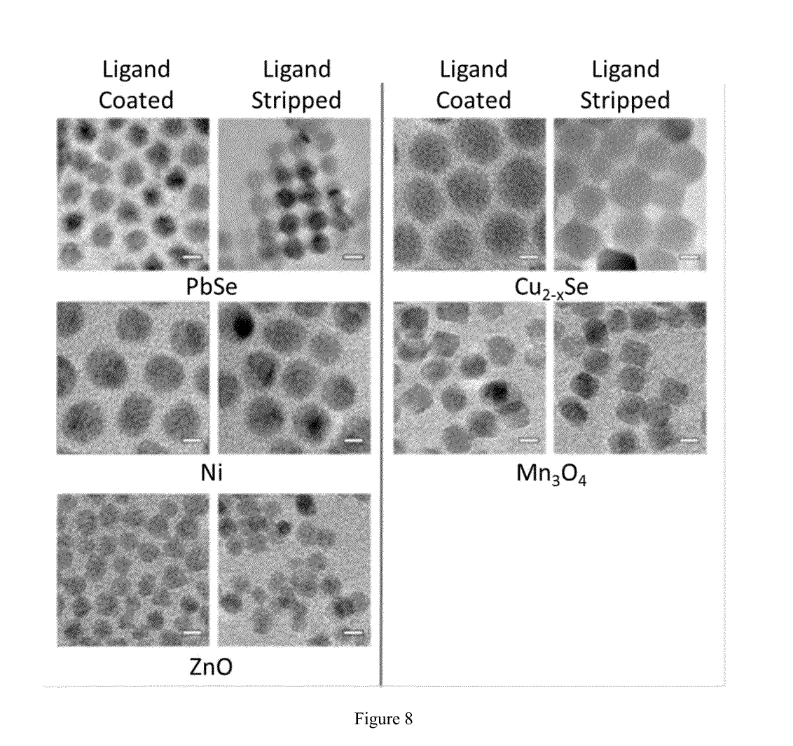

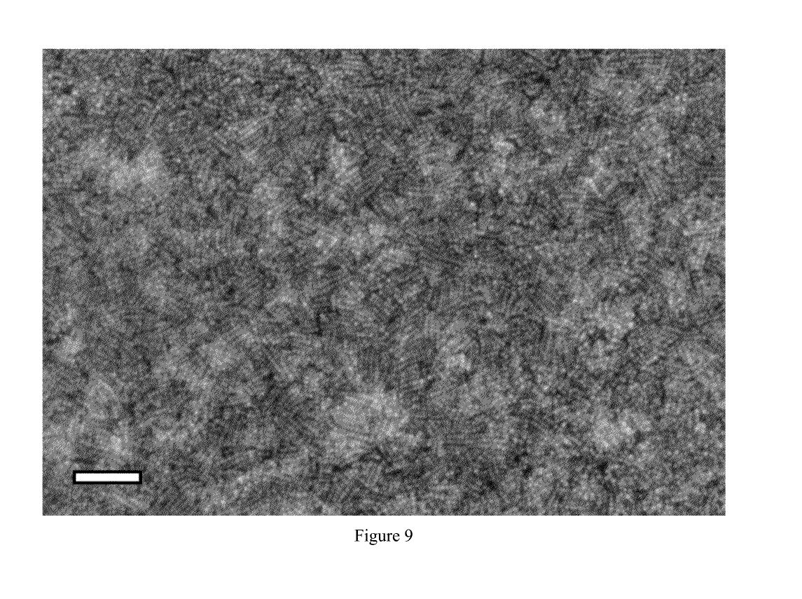

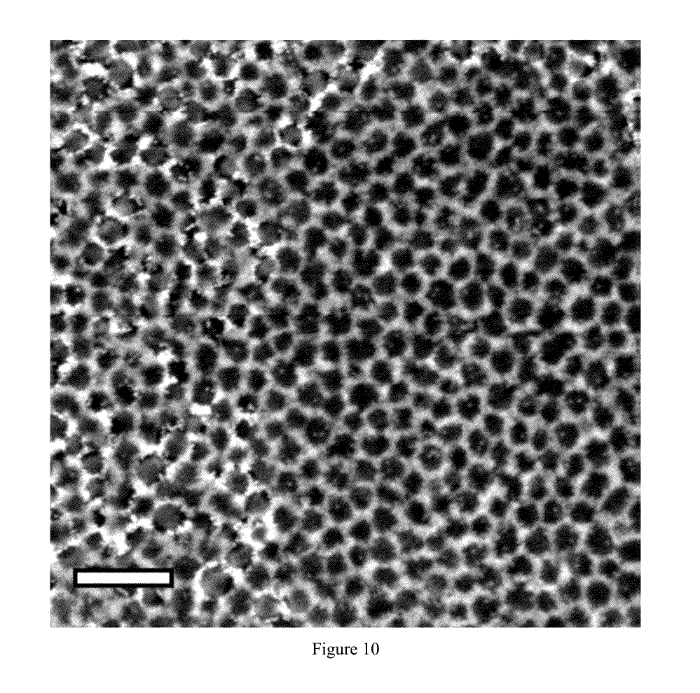

Given that no exogenous ions of the type Y⁻ were added to the ligand-stripping solution, it was necessary to establish the chemical identity of Y⁻ and its mechanistic origins as the compensating charge at the cationic naked PbSe nanocrystal surface. FT-IR of a thin film of naked PbSe nanocrystals showed a strong peak at 1120 cm⁻¹, suggesting the presence of BF₄⁻ even though no BF₄⁻ was added to the ligand-stripping solution. To confirm that BF₄⁻ was present in the purified dispersions of naked PbSe nanocrystals, ¹⁹F NMR was carried out. Strong peaks at δ=−151.72 and −151.77 ppm with a 1:4 ratio in integrated intensity were observed, consistent with isotopic shifts due to bonding of ¹⁹F to ¹⁰B and ¹¹B, respectively (FIG. 2). The assignment of this peak to BF₄⁻ was made by acquiring the ¹⁹F NMR spectrum of NaBF₄ in DMF, and noting a similar chemical shift as that observed for our naked PbSe dispersions (FIG. 2a-b). We also noted that BF₄⁻ in naked PbSe dispersions is only weakly, if at all, associating with the nanocrystal surface in DMF (FIG. 2c-d).

In order to establish the origins of the formation of BF4-, we acquired the ¹⁹F NMR spectrum for BF₃:Et₂O in DMF-d₇. The major chemical species present is the DMF adduct of BF₃ at δ=−152.4 ppm; this adduct accounting for 96% of the fluorine in the system, alongside two minor fluorine-containing species. The chemical shifts of these minor species were δ=−150.8 and −151.8 ppm, and were present in ˜1:2 ratio in integrated intensity. Based on the chemical shift, the peak at δ=−151.8 ppm can be assigned to BF₄⁻. These data are consistent with the disproportionation of DMF:BF₃ to form [(DMF)₂BF₂]⁺ and BF₄⁻, thus accounting for one possible source of BF₄⁻ counter-ions in naked PbSe nanocrystal dispersions (Scheme 2).

From the view of electroneutrality, the replacement of anionic oleate ligands with non-coordinating BF₄⁻ counter-ions at the nanocrystal surface requires both generation of BF₄⁻ and either conversion of oleate anions to a neutral species or pairing of oleate with a cationic species (i.e., OA⁻ with [(DMF)₂BF₂]⁺). We sought to understand oleate speciation post-stripping by performing ESI-MS on a reaction mixture of Pb(OA)₂ and BF₃:Et₂O in benzene-d₆ (FIG. 3). It is known from previous work that carboxylates can coordinate one or two equivalents of BF₃, and that carboxylate BF3 adducts can undergo disproportionation reactions to generate BF₄⁻ and [B(O₂CR)ₙF₄₋ₙ]⁻. In accordance with this known reactivity pathway, ESI-MS indicates that our reaction mixture contains OA⁻ (1, m/z=281.25, calc. 281.25), [OA:BF₃]⁻ (2, m/z=349.26, calc. 349.25), [OA(BF₃)₂]⁻ (3, m/z=417.26, calc. 417.26), and [B(OA)₂F₂]⁻ (4, m/z=611.50, calc. 611.50) (Scheme 3, FIG. 3). In addition to anionic disproportionation products, we also observe species that result from the hydrolysis of neutral disproportionation products in the presence of adventitious water. For example, fluoride transfer from [OA:BF₃]⁻ (2) to BF₃:Et₂O generates BF₄⁻ and OA(BF₂) (5), which readily dimerizes to form the neutral (OA)₂(BF₂)₂ species. While this dimer is not directly observable by ESI-MS due to its lack of charge, the deprotonated hydrolysis product, [(OA)₂(BF₂)(BFO)]⁻ (6, m/z=657.50, calc. 657.51) was observed. The [OA(BF₃)₂]⁻ adduct 3 can also undergo fluoride loss to generate BF₄⁻ and neutral OA(BF₃)(BF₂). Again, this neutral species is undetectable by ESI-MS, but we observe the deprotonated form of the hydrolysis product, [OA(BF₂)(BF₂O)]⁻ (7, m/z=395.26, calc. 395.26). The transfer of fluoride from BF₃ oleate adducts to excess BF₃:Et₂O provides a pathway for the conversion of anionic oleate ligands into neutral species along with the generation of non-coordinating BF₄⁻. It is also worth noting that in addition to [OA:BF₃]⁻, the anionic species formed along this pathway also have the ability to stabilize nanocrystal surfaces during the stripping process.

The unprecedented access to stable dispersions of cationic naked PbSe nanocrystals allowed us to better control their mesoscale order in thin films and composites, yielding new classes of meso-structured materials with applications as energy conversion materials. For example, thin films of lead chalcogenide nanocrystals are common active layers in Schottky-type solar cells, field effect transistors, NIR photodetectors, and thermoelectrics. As synthesized (i.e., with ligands intact), they can be assembled into periodic lattices with hexagonal close packing (hcp). Where controlled propagation of energy in the film is required for the function of the device, ligand removal can be advantageous. As shown here and elsewhere, order is usually lost upon stripping ligands in thin films (FIGS. 4 and 9). In addition, cracks and defects can manifest as a result of the dramatic volume change that occurs when organics are liberated. In contrast to the colloidal glasses produced by in-film ligand removal, ordered thin films of naked PbSe can be prepared simply by casting their dispersions directly onto substrates. Apparent cubic packing is evidenced in the top-down SEM images (FIG. 4d), indicating significant differences in the preferred packing geometry for ligand-coated and ligand-stripped nanocrystals. To further distinguish packing geometries between the different PbSe nanocrystal films, grazing incidence small angle X-ray scattering (GISAXS) was carried out. Both ligand-stripped PbSe nanocrystal films in FIGS. 4c and 4d showed a decrease in interparticle spacing from ˜1.3 nm to ˜0.4 nm, consistent with ligand removal. However, films that were spin-coated from stripped dispersions of PbSe exhibited a tendency towards in-plane ordering as opposed to the isotropic packing observed in films that were stripped in-film (FIG. 4d).

The observed packing in films deposited from ligand-coated vs. ligand-stripped PbSe nanocrystals can arise from: differences in surface energies of exposed facets leading to preferred nanocrystal-to-nanocrystal orientations; differences in packing preferences for non-deformable objects (i.e., the naked PbSe) compared to partially-deformable ligand-coated particles; differences in interaction potentials available to the system to guide the assembly trajectory during solvent evaporation (van der Waals vs. electrostatics). As such, our work suggests new opportunities to control energy propagation in nanocrystal films through their packing in the active layers.

More elaborate mesostructured BCP-nanocrystal hybrid architectures were also possible using polystyrene-block-poly(N,N-dimethylacrylamide) architecture-directing agents. For example, naked nanocrystal inks of PbSe were mixed with architecture-directing BCPs and deposited onto Si substrates by drop-casting or spin-coating to prepare hierarchically ordered composites (FIGS. 5 and 10). Notably, no further thermal or solvent vapor treatment of the films was required to establish order. As measured by GISAXS, these composites exhibited an in-plane periodicity of 45 nm, with a peak width at half maximum of 0.008 Å⁻¹. These new materials were only accessible thanks to the improved control over surface chemistry granted by our new chemical approach, and the availability of naked nanocrystal inks of PbSe opens the door to creating a wide variety of new and interesting mesoscale architectures that have been impossible in the past.

The mechanistic insights gained in this work provide a much-needed framework for rationalizing the successes and failures of different chemical approaches for removing surface-bound ligands from nanocrystals while maintaining colloidal dispersability. We hypothesized that earlier approaches based on irreversible severing of nanocrystal-ligand bonds failed to maintain colloidal dispersability for sensitive compositions due to a lack of surface stabilization and concomitant desorption of excess metal cations from the nanocrystal surface. To address this shortcoming, we proposed the use of reversible Lewis acid-base chemistry to generate physisorbed anionic species that stabilize the nanocrystal surface until coordinating solvent is able to repassivate the surface. Using PbSe nanocrystal as a model system, we demonstrated that anionic BF₃ adducts of surface-bound ligands exchanged on-and-off the nanocrystal surface, providing stabilization. Furthermore, we showed that nanocrystal stripped under equilibrium control maintained colloidal stability and did not suffer from the excess surface metal desorption that can be problematic when using some irreversible ligand stripping reagents. As a result, ligand stripping under equilibrium control represents a powerful new class of reactions for modifying the surface chemistry of colloidal nanocrystal while maintaining colloidal stability.

Additional control was leveraged to prepare previously unobtainable mesostructured nanocrystal films and polymer-nanocrystal composites with high mass loadings of PbSe. Notably, these composites did not require any further thermal or solvent-vapor treatment to establish order, which simplifies their processing for final applications including photovoltaics, thermoelectrics, and NIR photodetectors. These new materials are expected to yield insights into the role of architecture on electronic, excitonic, and thermal transport in mesostructured materials and composites.

### Example 1

### Oleate-Passivated Lead Selenide Nanocrystals

An example of one embodiment of the present disclosure relates to the synthesis of oleate-passivated lead selenide nanocrystals (PbSe-OA). Lead selenide nanocrystals were synthesized under an inert atmosphere following slightly modified reported procedures. Briefly, selenium shot (960 mg, 12.2 mmol) was added to TOP (8.64 g, 23.3 mmol) in a 40 mL septum capped vial and stirred overnight in a nitrogen glovebox prior to the addition of diphenylphosphine (84 mg, 0.45 mmol). Separately, in a 100 mL three-necked flask, lead(II) oxide (1.34 g, 6 mmol), oleic acid (4.24 g, 15 mmol), and 1-octadecene (23.4 mL) was placed under vacuum at room temperature 15 min and then at 110° C. for 1 h to dry and degas the solution. After solution became colorless and transparent, the temperature was raised to 180° C. at which point the TOP-Se solution was rapidly injected. After this TOP-Se injection, the reaction temperature dropped to −150° C. and was kept at this temperature for the desired reaction time (5 min gave PbSe nanocrystals with ˜7 nm diameter). The reaction was cooled in a water bath. The nanocrystals were then purified by precipitation three times from hexanes using first ethanol (1x) and then acetone (2x) to give 460 mg purified nanocrystal (1.2 mmol (PbOA)_{0.2}PbSe, 24% yield).

### Example 2

### Copper Selenide Nanocrystals

An example of one embodiment of the present disclosure relates to the synthesis of copper selenide nanocrystals (Cu₂₋ₓSe). Copper selenide nanocrystals were synthesized under an inert atmosphere following slightly modified reported procedures. Briefly, selenium powder (94.8 mg, 1.2 mmol) was added to 1-octadecene (9 mL) and OAm (6 mL) in a 50 mL three-necked flask and placed under vacuum at room temperature and 110° C. for 15 min and 1 h, respectively to dry and degass the solution. Afterwards, the Se solution was placed under nitrogen flow and raised to 310° C. The solution was orange and transparent. Separately, in a 25 mL three-necked flask, CuCl (198 mg, 2 mmol), OAm (2 mL), and 1-octadecene (3 mL) were placed under vacuum at 110° C. for 15 min to dry and degas the solution. The solution was light green and transparent. Next, the copper-containing solution was rapidly injected into the Se-containing solution and the reaction temperature dropped to ˜285° C. The reaction temperature was allowed to recover to 300° C. and was kept at this temperature for 20 min before cooling in a water bath. The particles were then purified by precipitation three times from hexanes/toluene (50% v/v) using ethanol.

### Example 3

### Nickel Nanocrystals

An example of one embodiment of the present disclosure relates to the synthesis of nickel nanocrystals (Ni). Nickel nanocrystals were synthesized under an inert atmosphere following slightly modified standard procedures. Briefly, nickel(II) 2,4-pentanedionate hydrate (84.7 mg, 0.33 mmol) was added to TOP (1 mL) in a 40 mL septum capped vial and in a nitrogen glovebox and then sonicated for 10 min to form a green/blue solution. In a separate 25 mL three-necked flask, OAm (10 mL) was placed under vacuum at room temperature and 110° C. for 15 min and 1 h, respectively to dry and degas the solvent. The OAm was cooled to RT prior to the injection of the Ni-TOP solution. The reaction temperature was raised at a rate of 10° C. min⁻¹ to 250° C. and allowed to react for 30 min. The reaction was cooled in a water bath. The particles were then purified by precipitation three times from hexanes/toluene (50% v/v) using ethanol.

### Example 4

### Manganese Oxide Nanocrystals

Synthesis of manganese oxide nanocrystals (Mn₃O₄). Manganese oxide nanocrystals were synthesized in air following established procedures. Briefly, manganese acetate (513 mg, 3.0 mmol), stearic acid (1.71 g, 6.0 mmol), and OAm (9.9 mL, 30 mmol) were dissolved in xylene (45 mL) in a 250 mL two neck flask with redox condenser and heated to 90° C. with stirring. Water (3 mL) was rapidly injected and the solution turned from clear dark brown to cloudy and light brown. The reaction temperature was held at 90° C. for 3 h, followed by cooling to room temperature. All solids were removed from the reaction mixture by centrifugation, and 350 mL ethanol was added to precipitate Mn₃O₄ nanocrystals. The nanocrystals were purified by precipitation three times from hexanes using acetone.

### Example 5

### Zinc Oxide Nanocrystals

Synthesis of zinc oxide nanocrystals (ZnO). Zinc oxide nanocrystals were synthesized in air following slightly modified procedures. Briefly, potassium hydroxide (902 mg, 16 mmol) was dissolved in methanol (150 mL) in a 500 mL round-bottom flask. The solution was heated to 60° C. with stirring and held at this temperature for 30 min. Next, a stock solution of zinc acetate dihydrate (1.757 g, 8.0 mmol) in methanol (50 mL) was added to the potassium hydroxide solution. The reaction was allowed to proceed for 2 h at 60° C., after which time the mixture was allowed to cool to RT naturally. The reaction mixture volume was reduced to 50 mL under reduced pressure at 40° C. Zinc oxide nanocrystals were precipitated by adding 5 equivalents of hexanes and 1 equivalent of isopropanol followed by centrifugation. The nanocrystals were redispersed in the minimal volume of methanol, and the precipitation and redispersion steps were repeated twice. On the final redispersion step the nanocrystals were redispersed in chloroform (3 mL) containing 375 μL OAm and 121 μL OA. The nanocrystals were precipitated with acetone and purified by precipitation three times from hexanes using acetone.

### Example 6

### TiO2 Nanocrystals

Synthesis of TiO₂ nanocrystals. TiO₂ nanocrystals were synthesized under an inert atmosphere following established procedures. Briefly, OA (35.0 g, 124 mmol) was dried under vacuum at 120° C. for 60 min in a 100 mL 3-neck flask. The temperature was reduced to 90° C. and the flask was filled with nitrogen. Titanium tetraisopropoxide (1.5 mL, 5.1 mmol) was rapidly injected to yield a clear, yellow solution. After 5 minutes, a stock aqueous solution of trimethylamine-N-oxide (2 M, 5 mL, 10 mmol) was injected, at which point the reaction mixture turned white and cloudy. The reaction was held at 90° C. with stirring for 5 h and allowed to cool to RT naturally. The nanocrystals were precipitated by adding 120 mL ethanol. The nanocrystals were recovered by centrifugation and purified three times by precipitation from hexanes using acetone.

Ligand stripping procedure: Activated N,N-dimethylformamide (DMF) was prepared in a nitrogen glovebox by adding BF₃:Et₂O (20 μL, 0.16 mmol) to 500 μL DMF and mixing vigorously. Next, 500 μL of a stock solution of nanocrystals in hexanes (5-10 mg mL⁻¹) was added to the activated DMF and mixed vigorously. Toluene (3.5 mL) was then added to induce mixing of the two layers and precipitation of stripped nanocrystals, which were redispersed in DMF. The resulting naked nanocrystal dispersion was purified by multiple washes with hexanes and precipitation from DMF with toluene.

In a preferred embodiment, stripping is carried out with boron trifluoride diethyletherate. Other preferred embodiments include stripping with the following solvents/solvent mixtures: DMF/hexanes, DMF/toluene, acetonitrile/hexanes, acetonitrile/toluene, hexamethylphosphoramide/hexanes, and hexamethylphosphoramide/toluene, or others. In each of these embodiments, boron trifluoride diethyletherate reacts with other solvents to make BF₃:DMF, BF₃:acetonitrile, and BF₃:hexamethylphosphoramide complexes.

Additional preferred embodiments use Lewis acids to strip ligands. In such embodiments, PF₅, PCl₅, SbF₅, SbCl₅, FeCl₃, AlCl₃ can all be used as reagents that act in a similar manner to BF₃.

In another embodiment, stripping is accomplished by exposing a solid sample of nanocrystal material to a stripping reagent dissolved in HMPA, DMF, acetonitrile, or other solvent.

Preferred embodiments of nanocrystal materials include both BF₄⁻ and bis(trifluoromethanesulfonyl)imide counterions. Other preferred embodiments contain additional counter-ions, including Cl⁻, Br⁻, F⁻, NO₃⁻, PF₆⁻, PCl₆⁻, SbF₆⁻, SbCl₆⁻, FeCl₄⁻, AlCl₄⁻ along with others by way of ion exchange.

Stripping can also be performed with other complexes of BF₃.

ESI-MS: A reaction mixture of Pb(OA)₂ and BF₃:Et₂O was prepared by dissolving Pb(OA)₂ (3 mg, 4 μmol) in 700 μL benzene-d₆ and adding BF₃:Et₂O (8 μmol). For improved ionization efficiency, the reaction mixture was diluted 5-fold with dry acetonitrile to prepare the final ESI-MS sample. ESI-MS was run in negative ion mode.

Preparation of naked nanocrystal thin films and polymer composites: Thin films of PbSe-OA were prepared by spin-coating a solution of PbSe-OA in 1:1 hexane:octane onto a silicon wafer. To strip the nanocrystal film in the solid state, the film was dipped into a solution of BF₃:Et₂O (50 μL) in HMPA (1 mL) and rinsed with hexanes. Ordered thin-films of naked PbSe nanocrystal could be prepared by spin-coating a solution (˜10 mg mL⁻¹) of naked PbSe nanocrystal directly onto a silicon wafer. Architecture-directing 20 kDa-60 kDa PS-b-PDMA block copolymers were prepared as described by us elsewhere and dissolved in DMF to form a stock solution at a concentration of 50 mg mL⁻¹. Separately, a 30 mg mL⁻¹ stock solution of naked PbSe nanocrystal in DMF was prepared. The stock solutions were mixed along with excess DMF to yield a solution with a final concentration of 10 mg mL⁻¹ polymer and 3-10 mg mL⁻¹ nanocrystal, which was dropcast directly onto an Si wafer to produce ordered polymer-nanocrystal composites.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

We claim:

1. An inorganic material comprising ionic nanocrystalline material wherein the material is colloidally stable.

2. The material of claim 1, wherein said ionic nanocrystalline material comprises a crystallite wherein said crystallite grain size is equal to or less than 100 nanometers.

3. The material of claim 1, wherein said ionic nanocrystalline material comprises surface charge density with a zeta potential of above +25 mV.

4. The material of claim 1 wherein said colloidally stable ionic nanocrystalline material is comprised from at least one of the following: lead selenide, lead sulfide, tin-doped indium oxide, cadmium sulfide, cadmium selenide, nickel, titanium oxide, zinc oxide, zinc sulfide, zinc selenide, and manganese oxide.

5. The material of claim 1 further wherein said materials have the chemical structures of (M^{m+})ₐ(Yⁿ⁻)_{b}(L)_{c}(MₓE_{y})_{z}, where:
a is greater than zero;
b is greater than zero;
c is at least zero;
m is greater than zero;
n is greater than zero;
x is greater than zero;
y is at least zero;
z is greater than zero;
L is a charge neutral adsorbate or a mixture of two or more charge neutral adsorbates;
Y is a counter ion or a mixture of two or more counterions;
M is comprised of at least one from one of the following;
an alkali metal;
an alkali-earth metal;
a transition metal;
a main-group semi-metal;
a lanthanide;
an actinide;
a mixture of two or more metals;
a mixture of two or more main group semi-metals;
a mixture of one or more transition metals and one or more main group semi-metals;
a mixture of one or more transition metals and one or more alkali metals;
a mixture of one or more transition metals and one or more alkali-earth metals;
a mixture of one or more transition metals and one or more lanthanides;
a mixture of one or more transition metals and one or more actinides;
a mixture of one or more alkali metals and one or more lanthanides; and
E is at least one or a combination of elements selected from one or more of the following groups: carbide, pnictides, chalcogenides, halides, and other inorganic anions.

6. The material of claim 5 further wherein said materials have the chemical structures of: (Pb²⁺)ₐ(BF₄⁻)_{b}(DMF)_{c}(PbSe)ₙ, (Pb²⁺)ₐ(BF₄)_{b}(DMF)_{c}(PbS)ₙ.

7. The material of claim 5 further wherein M is selected from the group of Pb, Al, Co, Ni, Pd, Na, Li, Ga, Cd, Ti, Fe, V, Mn, In, Cu, Sn, and Zn.

8. The material of claim 5 further wherein said E is selected from C, N, P, As, Sb, O, S, Se, Te, F, Cl, Br, I, phosphate, orthovanadate, oxysilicate.

9. The material of claim 8 further wherein M is selected from the group of Pb, Al, Co, Ni, Pd, Na, Li, Ga, Cd, Ti, Mn, In, Cu, and Zn.

10. A method of producing an inorganic material comprising ionic nanocrystalline material through native ligand stripping under equilibrium control where reversibly generated Lewis acid-base adducts stabilize surfaces.

11. The method of claim 10 wherein said Lewis acid-base adducts are to metal halides.

12. The method of claim 10 wherein Lewis acids of said Lewis acid-base adducts comprise one or more of BF₃, BCl₃, BBr₃, AlCl₃, PCl₅, PF₅, SbCl₅, SbF₅, FeCl₃ or AuCl₃.

13. The method of claim 11 wherein metals of said metal halides comprise elements from boron, aluminum, antimony, gold, iron, or phosphorus.

14. The method of claim 11 wherein Lewis bases of said Lewis acid-base adducts comprise one or more of alkyl ethers, alkyl sulfides, alkyl carbonates, alkyl amines, aromatic ethers, aromatic sulfides, aromatic carbonates, aromatic amines, DMF, NMP, HMPA, acetonitrile, DMSO, coordinating organic ligands.

15. The method of claim 11 wherein said metal halides react with the carboxylate, carbonate, thiocarbonate, dithiocarbonate, trithiocarbonate, carbamate, thiocarbamate, dithiocarbamate, amine, tetrazole, tetrazolate, imidazole, imidazolate, thiol, thiolate, selenides, telluride, phosphonate, pyrophosphonate, phosphinate, phosphine, phosphine oxide, or alcohol terminus of coordinating organic ligands to form a physisorbed adduct.

16. The method of claim 15 wherein said coordinating organic ligands comprise elements from the non-metals, including but not limited to, carbon, nitrogen, phosphorus, arsenic, oxygen, sulfur, selenium, tellurium.

17. A method of producing ligand-stripped nanocrystal thin films and polymer composites comprising:
depositing a film using a dispersion of PbSe-OA in a mixture comprising hexane and octane onto a silicon wafer; and
stripping said nanocrystal film in a solid state by dipping said film into a solution of metal halide to diethyl ether in HMPA and rinsing with hexanes.

18. The method of claim 17 wherein said metal halide comprises elements from boron, aluminum, antimony, gold, iron, and phosphorus.

19. A method of preparing a film of ligand-stripped inorganic ionic nanocrystals comprising deposition of a dispersion of ligand-stripped inorganic ionic nanocrystals directly onto a substrate.

20. A method of preparing a composite film of ligand-stripped inorganic ionic nanocrystals and polymers wherein a dispersion comprising polymers and ligand-stripped inorganic ionic nanocrystals is deposited directly onto a substrate to produce ordered polymer-nanocrystal composites.

21. The method of claim 20 further wherein said ligand-stripped inorganic ionic nanocrystal material is subsequently annealed through known steps.

22. The method of claim 20 further wherein said substrate comprises one from the group of:
a wafer comprising an element from the group comprising metals and metalloids;
a plastic;
a porous support comprising metals, conductors, semiconductors, or insulators.

23. The method of claim 22 wherein mesostructured films comprise block copolymers with coordinating functional groups comprising carboxylates, amides, esters, amines, sulfides, thiols, phosphonates, phosphines, phosphine oxides, and alcohols.
